(19) United States
(12) Patent Application Publication
(10) Pub. No.: US 2007/0012619 A1
(43) Pub. Date: Jan. 18, 2007

(54) Method for purifying coke waste water using a gas-permeable membrane

(76) Inventor: Holger Thielert, Dortmund (DE)

Correspondence Address: WILLIAM COLLARD;COLLARD & ROE, P.C., 1077 NORTHERN BOULEVARD, ROSLYN, NY, 11576, US

(21) Appl. No.: 10/554,256

(22) PCT Filed: Mar. 30, 2004
(86) PCT No.: PCT/EP04/03353

§ 371 Date: Dec. 14, 2005

(30) Foreign Application Priority Data
Apr. 25, 2003 (DE) 103 18 736.7

(51) Int. Cl. C02F 3/30

(52) U.S. Cl. 210/605

(57) ABSTRACT

The invention relates to a method for purifying coke waste water that is charged with nitrogen compounds, cyanides and sulfides. According to the inventive method, the coke waste water passes through a reactor (3) that is integrated into a liquid cycle (2) and that comprises at least one gas-permeable membrane tube (5) whose interior is impinged upon by an oxygenous pressurized gas (4). On the exterior of the membrane tube (5) which is immersed in the liquid, a biofilm (6) is maintained in whose inner region (7) rich in oxygen due to the gas-permeability of the membrane tube (5) nitrogenous compounds are selectively nitrified to nitrates while at the same time nitrates are denitrified to elemental nitrogen in an oxygen-poor outer region (8) of the biofilm (6).

The invention relates to a method for purifying coke oven waste water that is charged with nitrogen compounds, such as N₄⁺, NO₂⁻, NO₃⁻ ions as well as cyanides and sulfides.

In the state of the art, purification of this coke oven waste water is carried out in multi-stage methods inside large-volume containers. In general, denitrification takes place first, in the absence of oxygen, during which NO₃⁻ ions are decomposed. Subsequently, decomposition of carbon, i.e. CSB decomposition, takes place using aerobic bacteria strains. Afterwards, intermediate clarification takes place, during which biomass that has been floated along is separated. This is followed by nitrification, which is generally configured as carrier biology. Plastic filler bodies are used as a carrier material for immobilizing the microorganisms. During this method step, a conversion of NH₄⁺ ions to NO₂⁻ and NO₃⁻ ions takes place. This is followed by a second denitrification step, in which the NO₂⁻ and NO₃⁻ ions are converted to elemental nitrogen (N₂) This is followed by subsequent aeration to enrich the activated sludge with oxygen, and by subsequent clarification, in which the activated sludge is separated from the waste water.

The chemical processes that occur during nitrification and denitrification can be described with the reaction equations indicated in the following:

Conversion of compounds that contain nitrogen by means of nitrification:

$${NH}_{4}^{+} + \frac{3}{2} {O}_{2} {•NO}_{2}^{-} + {H}_{2} O + 2 {H}^{+}$$

$${NO}_{2}^{-} + \frac{1}{2} {O}_{2} {• NO}_{3}^{-}$$

Decomposition of nitrates by means of denitrification in the absence of oxygen:
10H+2NO₃⁻□2OH⁻N₂+4H₂O

Organic carbon compounds can serve as hydrogen donators during denitrification.

A great disadvantage of conventional biological purification methods consists in the fact that oxygen and substrate transport directed in the same direction takes place from the outside into the bacteria floccules. Therefore nitrification takes place in oxygen-limited manner, and a large portion of the nitrificants contained in the bacteria floccules does not participate in the conversion. This can be seen as a significant reason for the fact that the conventional bacterial purification methods cause a high space requirement and, along with that, high investment and operating costs.

The invention is based on the task of indicating a method for purifying coke oven waste water charged with nitrogen compounds, cyanides, and sulfides, which method permits low investment and operating costs.

The object of the invention and the solution for the task is a method for purifying coke oven waste water charged with nitrogen compounds, cyanides, and sulfides,
whereby the coke oven waste water flows through a reactor that is part of a liquid circulation system, which reactor contains at least one gas-permeable membrane tube that is impacted on the inside by a pressurized gas that contains oxygen, and
whereby a biofilm is maintained on the outside of the membrane tube around which liquid flows, where selective nitrification of nitrogen-containing compounds contained in the waste water to nitrates takes place in the inner region that is rich in oxygen because of the gas permeability of the membrane tube and, at the same time, denitrification of nitrates to elemental nitrogen takes place in an outer region of the biofilm that is poor in oxygen.

The method according to the invention permits effective decomposition of contaminants that contain nitrogen. The use of the reactor described guarantees very high nitrification rates and simultaneously very high denitrification rates. Because of the gas-permeable membrane tube, it is possible to supply the microorganisms of the biofilm with substrate and oxygen, independent of one another. While an oxygen-poor environment exists on the outside of the biofilm, which allows very high denitrification rates in this region, very good nitrification rates can be achieved in the regions of the biofilm that are directly adjacent to the surface of the membrane tube, because of the abundant supply of oxygen that prevails there. The separate nitrification and denitrification stages that are required for conventional biological purification methods can be brought together into a single method step in the case of the method according to the invention. In this way, the expenditure for apparatus, the space requirement, as well as the investment and operating costs can be clearly reduced as compared with conventional methods. The compact construction allows production-integrated use at clearly higher concentrations than in the final waste water, thereby significantly facilitating the purification of the waste water.

The reactor used in the method according to the invention, having a gas-permeable membrane tube, is actually known. Until now, however, such a reactor was used only for experimental purposes with synthetic waste water types and organically charged waster water from slaughterhouses. Surprisingly, however, the reactor is also suitable for purifying coke oven waste water, which, in contrast to the uses mentioned above, is charged with cyanides and sulfides. The biofilm that adheres to the surface of the membrane tube is formed when microorganisms deposit on the border surfaces and grow there. In this connection, the biofilm can consist either of substances contained in the waste water and/or of biosludges added to the waste water. Preferably, pore-free tubes, e.g. silicone membrane tubes, are used as the membrane tubes. A polyester yarn that is coated with silicon has particularly proven itself in this connection. Elemental oxygen (O₂), but also carbon dioxide (CO₂) can be used as the pressurized gas that contains oxygen.

Preferably, several reactors are switched in series within the liquid circulation system, through which the liquid stream flows, one behind the other. Analogously, several membrane tubes impacted by a pressurized gas that contains oxygen can also be disposed in the flow space of a reactor, one behind the other. The thickness of the biofilm is regulated by way of the flow velocity of the liquid in the reactor. This prevents an overly strong growth of the denitrification layer, which can be accompanied by clogging of the reactor. Starting from a thickness of 100 to 200 μm, biofilms no longer participate in the substance conversion. Therefore the formation of overly thick biofilms must be prevented. By adjusting a suitable flow velocity, biofilms having a great thickness are sheared off, and the formation of an overly great film thickness is prevented. Using continuous monitoring of analysis measurement data within the liquid circulation system, it can be determined whether an optimal flow speed exists for the biological purification.

Preferably, the pressurized gas stream that is passed to the membrane tube is regulated using analysis values of the waste water that are measured in the liquid circulation system. This allows very high denitrification rates on the outside of the biofilm, and simultaneously, very high nitrification rates in the inner region of the biofilm that is adjacent to the membrane tube. Suitable measurement values are, for example, the O₂, NH₄⁺, NO₃⁻, NO₂⁻, CO₂ as well as N₂ content in the liquid circulation system. The targeted regulation of the pressurized gas stream that is supplied allows precise control and/or regulation of the denitrification and nitrification processes that are occurring.

Before removal of a purified partial stream from the liquid circulation system, this partial stream is freed of biofilm particles, preferably using a clarification device that is integrated into the liquid circulation system. This prevents the purified waste water that leaves the purification system from being contaminated with sludge. Possible clarification devices are a final sedimentation tank, within which sedimentation of the biofilm particles takes place, or a centrifuge. Feed of non-purified coke oven waste water into the liquid circulation system is preferably regulated or controlled using analysis values of the purified waste water. This allows reliable adherence to limit values and, at the same time, stable behavior in the reactor. Again, analysis values can be, for example the content of O₂, NH₄⁺, NO₃⁻, NO₂⁻, CO₂ as well as N₂ in the liquid circulation system. This makes a targeted adjustment of the dwell time of the waste water in the liquid circulation system possible.

The non-purified coke oven waste water can be passed through a chemical precipitation stage before being introduced into the liquid circulation system. This prior first purification stage relieves the burden on the biological purification method. By adding FeCl₃, for example, part of the nitrogen compounds is already removed from the waste water in the chemical precipitation stage.

The temperature of the waste water in the reactor is preferably adjusted by way of a heat exchanger. In this way, a uniform, optimal temperature for the microorganisms can be guaranteed. In this connection, the heat exchanger is integrated into the liquid circulation system of the waste water to be purified.

In the following, the invention will be explained in detail using a drawing that represents an embodiment merely as an example. The drawing schematically shows:

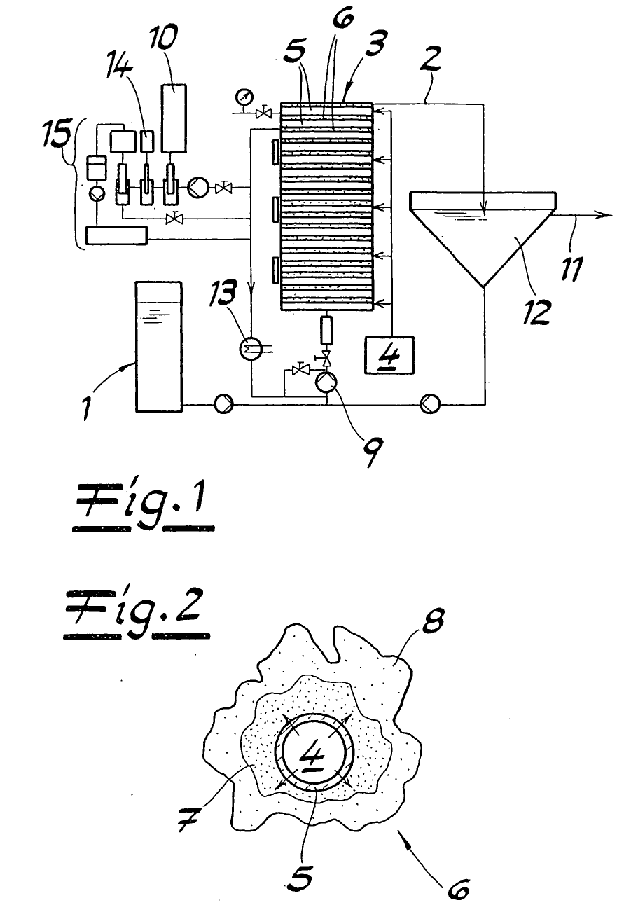

FIG. 1 a method flowchart of the biological purification method according to the invention, and

FIG. 2 a cross-section through a gas-permeable membrane tube impacted by pressurized gas, in a reactor used according to the invention.

FIG. 1 shows a schematic structure of the biological method according to the invention, for purifying coke oven waste water charged with nitrogen compounds, cyanides, and sulfides. The coke oven waste water to be purified is fed into a liquid circulation system 2, into which a reactor 3 through which coke oven waste water flows is integrated, from a supply container 1. The reactor 3 contains several gas-permeable membrane tubes 5 to which pressurized gas 4 that contains oxygen is applied on the inside. In the exemplary embodiment, elemental oxygen is used as the pressurized gas 4 that contains oxygen. A biofilm 6 is maintained on the outside of the membrane tubes 5, over which the liquid flows. Because of the gas permeability of the membrane tube 5, selective nitrification of the compounds containing nitrogen, to produce nitrates, takes place in the oxygen-rich inner region 7 of the biofilm 6. At the same time, denitrification of nitrates to produce elemental nitrogen takes place in an oxygen-poor outer region 8 of the biofilm 6. This becomes particularly clear in FIG. 2, which represents a cross-section through the gas-permeable membrane tube 5 mantled by the biofilm 6. While an abundant supply of oxygen is present in the region 7 of the biofilm 6 that lies directly adjacent to the surface of the membrane tube 5, assuring very high nitrification rates there, a very low oxygen concentration is present on the outside 8 of the biofilm 6, which in turn allows very high denitrification rates in this region 8. Because of the uncoupling of the substrate supply and the oxygen supply of the microorganisms of the biofilm 6, both nitrification processes and denitrification processes can take place at very high rates, within a very small space. As compared with conventional biological purification methods, in which nitrification and denitrification must be carried out in separate containers, one after the other, the method according to the invention is characterized by very low apparatus expenditure, a low space requirement, and, at the same time, low investment and operating costs.

The membrane tube 5 used in the exemplary embodiment consists of a polyester yarn coated with silicon. The outside diameter of the membrane tube is 3 mm, with a wall thickness of 0.5 mm. The specific surface of the tube is between 20 and 200 m²/m³. The biofilm 6 adhering to the membrane tube 5 arises from substances contained in the waste water and/or biosludges added to the waste water. In this connection, the microorganisms deposit on the surface of the membrane tube and grow there.

The thickness of the biofilm is regulated using a pump 9, by way of the flow velocity of the liquid in the reactor 3. In this way, overly strong growth of the denitrification layer 8 is prevented; this could result in clogging of the reactor 3. Starting from a thickness of 100 to 200 μm, biofilms no longer participate in the substance conversion. The flow adjusted using the pump 9 shears off regions having a great thickness, and thereby prevents an overly great biofilm thickness.

The pressurized gas stream 4 that is supplied to the membrane tube 5 is regulated using analysis values of the waste water that are measured in the liquid circulation system 2. In this way, very high denitrification rates on the outside 9 of the biofilm 6 and very high nitrification rates in the inner region 7 of the biofilm 6 can be adjusted at the same time, in targeted manner. The analysis values are continuously monitored by way of measurement instruments 10. Before removal of a purified partial stream 11 from the liquid circulation system 2, this partial stream 11 is freed of biofilm particles using a final sedimentation tank 12 that is integrated into the liquid circulation system 2. In this way, entrainment of biosludge into the purified waste water is prevented. A feed of non-purified coke oven waste water from the supply container 1 into the liquid circulation system 2 is regulated or controlled using analysis values of the purified waste water. This allows reliable adherence to limit values, and, at the same time, stable operation within the reactor 3. Because of the dilution that occurs in this connection, problematic components such as cyanides and sulfides can also be mastered. A heat exchanger 13 is also integrated into the liquid circulation system 2, in order to be able to adjust the temperature of the waste water in the reactor 3. In this way, an optimal temperature can be reliably guaranteed for the microorganisms of the biofilm 6. The temperature is monitored using an appropriate measurement device 14. Furthermore, a pH regulation device 15 is provided, in order to be able to adjust the concentration of H⁺ and OH⁻ ions in the liquid circulation system 2.

1. Method for purifying coke oven waste water charged with nitrogen compounds, cyanides, and sulfides,
whereby the coke oven waste water flows through a reactor (3) that is part of a liquid circulation system (2), which reactor contains at least one gas-permeable membrane tube (5) that is impacted on the inside by a pressurized gas (4) that contains oxygen, and
whereby a biofilm (6) is maintained on the outside of the membrane tube (5) around which liquid flows, where selective nitrification of nitrogen-containing compounds contained in the waste water to nitrates takes place in the inner region (7) that is rich in oxygen, because of the gas permeability of the membrane tube (5) and, at the same time, denitrification of nitrates to elemental nitrogen takes place in an outer region (8) of the biofilm (6) that is poor in oxygen.

2. Method according to claim 1, whereby several reactors (3) are switched in series within the liquid circulation system (2), through which the liquid stream flows, one behind the other.

3. Method according to claim 1, whereby the thickness of the biofilm (6) is regulated by way of the flow velocity of the liquid in the reactor (3).

4. Method according to claim 1, wherein the pressurized gas stream (4) that is passed to the membrane tube (5) is regulated using analysis values of the waste water that are measured in the liquid circulation system (2).

5. Method according to claim 1, wherein before removal of a purified partial stream (11) from the liquid circulation system (2), this partial stream (11) is freed of biofilm particles, preferably using a clarification device (12) that is integrated into the liquid circulation system (2).

6. Method according to claim 1, wherein feed of non-purified coke oven waste water into the liquid circulation system (2) is regulated or controlled using analysis values of the purified waste water.

7. Method according to claim 1, wherein the non-purified coke oven waste water is passed through a chemical precipitation stage before being introduced into the liquid circulation system (2).

8. Method according to claim 1, wherein the temperature of the waste water in the reactor (3) is adjusted by way of a heat exchanger (13).

9. Method for purifying coke oven waste water charged with nitrogen compounds, cyanides, and sulfides,
whereby the coke oven waste water flows through a reactor (3) that is part of a liquid circulation system (2), which reactor contains at least one gas-permeable membrane tube (5) that is impacted on the inside by a pressurized gas (4) that contains oxygen, and
whereby a biofilm (6) is maintained on the outside of the membrane tube (5) around which liquid flows, the thickness of which is regulated by the flow velocity of the liquid in the reactor (3),
whereby the pressurized gas stream (4) supplied to the membrane tube (5) is adjusted in such a manner that the biofilm (6) has an oxygen-rich inner region (7) that follows the membrane tube (5), in which nitrification of nitrogen-containing compounds contained in the waste water to nitrates takes place at a high nitrification rate, and that the biofilm (6) has an outer region (8) that is poor in oxygen, in which denitrification of nitrates to elemental nitrogen takes place at the same time, at a high denitrification rate.
